(19) United States
(12) Patent Application Publication
(10) Pub. No.: US 2016/0269947 A1
(43) Pub. Date: Sep. 15, 2016

(54) WIRELESS DEVICE, RADIO ACCESS NETWORK NODE AND METHODS THEREIN FOR PROVIDING HANDOVER INFORMATION INCLUDING CELL IDENTITY

(71) Applicant: TELEFONAKTIEBOLAGET L M ERICSSON (PUBL), Stockholm (SE)

(72) Inventors: Elisabeth HANSSON, Linköping (SE); Tobias AHLSTRÖM, Ljungsbro (SE); Stefan ENGSTRÖM, Linköping (SE)

(73) Assignee: TELEFONAKTIEBOLAGET LM ERICSSON (PUBL), Stockholm (SE)

(21) Appl. No.: 15/033,346

(22) PCT Filed: Nov. 1, 2013
(86) PCT No.: PCT/SE2013/051278

§ 371 Date: Apr. 29, 2016

(51) Int. Cl. H04W 36/00; H04W 8/18

(52) U.S. Cl. CPC H04W 36/0061; H04W 8/183; H04W 36/04

(57) ABSTRACT

A wireless device for a cellular network comprises a receiver arranged to receive a request to report at least one second network cell suitable for handover, a processor arranged to determine the at least one second network cell suitable for handover among a set of available network cells and to form a response comprising a respective local cell identity associated with the at least one suitable second network cell, and a transmitter arranged to transmit the formed response. The processor is further arranged to determine a cell identity confusion risk involved for the set of available network cells based on information in the request and based on local cell identities associated with the set of available network cells, and measure a global cell identity for each at least one second network cell determined to be involved in a cell identity confusion risk.

### TECHNICAL FIELD

The present disclosure relates to a wireless device and a radio access network node for a cellular network, wherein each network cell is associated with a local cell identity.

The present disclosure also relates to a method in a wireless device of a cellular network for providing handover support information, wherein each network cell is associated with a local cell identity and wherein said wireless device is attached to a first network cell.

The present disclosure further relates to a method performed in a radio access network node of a cellular network for providing handover support information, wherein each network cell is associated with a local cell identity.

### BACKGROUND

In mobile cellular radio systems, a mobile station, MS, or user equipment, UE; is able to move between cells. The cells together provide radio coverage for the MS/UE as it moves around. In Long Term Evolution, LTE, the MS/UE identifies the cell by use of a signal sequence, broadcasted in the cell. Each signal sequence corresponds to a Physical Cell Identity. Each cell is associated to a Physical Cell Identity, PCI. When a MS/UE, served by a source cell, detects a better (e.g. in terms of signal strength or signal quality) cell, it reports the PCI of the better cell to the serving base station (eNB). The serving eNB can then decide to hand over the MS/UE to the better cell.

However, the number of PCIs available is characteristically substantially smaller than the number of cells in an LTE network. Therefore, there is a risk that the MS/UE can hear more than one cell having the same PCI from a source cell. If so, the associated serving eNB (source eNB) cannot distinguish between possible target cells for a handover and may try to move the MS/UE to wrong target cell. This may result in a failed handover.

PCI confusion appears when a MS/UE can hear, depending on location, two different cells with the same PCI from a serving cell. PCI confusion will have impact on the handover statistics, since a MS/UE cannot distinguish between two cells with the same PCI. PCI confusions may occur for different reasons.

One way of assigning PCIs is that a centralized server strives for assigning a PCI that is unique within the relevant area. However, there is a risk that a mobile station hears cell(s) that was not expected. This might results in PCI confusions since these cells were not taken into account when the PCI for a particular cell was decided.

In networks with small cells such as pico and home eNBs, the small cells are in one example assigned PCIs out of a limited reserved range. Considering a large amount of small cells it is likely that the PCI of the small cells are not unique within a large macro cell. In one example, there are 50 small cells in the area of a macro cell, and the small cells are decided to have a PCI in the range of 1 to 10. This results in PCI confusions that cannot be resolved.

Another way to assign PCIs is by use of a local algorithm in the eNB. The eNB then has knowledge about what PCIs the surrounding cells are using, and can select one that is not used in the surrounding area. Also here there is a risk that all surrounding cells are not known to the PCI assigning algorithm, due to missing configuration from management system or because automatic neighbor cell detection mechanisms cannot find duplicate neighbors with the same PCI.

In case of known or suspected PCI confusions, one way of an eNB to get to know a unique identity of a cell is to configure the mobile station to report an Evolved UTRAN Cell Global Identity, ECGI, of the cell. The mobile station will then read relevant Master Information Blocks, MIBs, and/or System Information Blocks, SIBs, during gaps in data transfer. The 3GPP standard allows ECGI reading to be performed during either idle periods configured by the eNB (Discontinuous Reception, DRX), or during an autonomous gap selected by the MS/UE itself.

For reading during an autonomous gap, the MS/UE is allowed to temporary abort the communication with the serving cell in order to make it possible to read the ECGI. The MS/UE succeeds in ECGI measurements on Evolved Universal Terrestrial Radio Access Network, E-UTRAN, cells within 150 ms, if radio conditions are good enough. If ECGI measurements are to be read with autonomous gap, the eNB sends Radio Resource Control CONNECTION RECONFIGURATION with reportCGl and a System Information-request for handover, si-RequestForHO. The MS/UE responds with a confirmation message, in one example denoted RRC CONNECTION RECONFIGURATION COMPLETE. If the MS/UE succeeds to read the ECGI, the ECGI is reported in a measurement report. The MS/UE is arranged to remove the ECGI measurement if the measurement has not succeeded within specified time. Thus, the eNB does not need to remove the ECGI measurement nor autonomous gap configuration.

If the MS/UE is not configured with autonomous gap, the MS/UE is arranged to only support the measurements with the purpose set to report CGI if E-UTRAN has provided sufficient idle periods (DRX). For ECGI measurement with idle period (DRX), there is a risk that the ECGI measurement fails if the MS/UE sends data. If ECGI measurements are to be read with DRX, the eNB is arranged to send a configuration message denoted RRC CONNECTION RECONFIGURATION with reportCGl. The MS/UE is also configured with DRX with long enough idle periods. The MS/UE is arranged to respond with a confirmation message denoted RRC CONNECTION RECONFIGURATION COMPLETE. In this case, the MS/UE is arranged to try to read the ECGI within 1 second. The ECGI is reported to the eNB if the ECGI measurement is successful. Otherwise, the MS/UE will remove the ECGI measurements after 1 second. The eNB may then remove the DRX configured for the ECGI measurement.

PCI confusion can result in handover failure, since a MS/UE cannot distinguish between two cells with the same PCI. Further, eNBs may have mechanisms for detecting and resolving PCI confusions, but it may take time before the PCI confusions are resolved. Furthermore, some PCI confusions are not possible to resolve. For example, small cells in pico or home eNBs may be deployed so densely that the reserved range of PCIs for those type of cells is not big enough to allow for unique PCIs in the complete coverage area of a large cell. Some operators may want to perform handover from macro eNB to small cells even though the PCI of the small cell is not unique within the macro eNBs. The solution provided today, with the eNB requesting the MS/UE to measure and report the E-CGI of the target cell for handover after the reception of a PCI report from the UE, delays the handover so that it will fail in some scenarios. The request for ECGI also consumes signaling over the interface.

### SUMMARY

Thus, one object is to provide an improved mechanism for performing handover to a correct target cell when the target cell is involved in a PCI confusion.

This has in accordance with one example been achieved by means of a wireless device for a cellular network, wherein each network cell is associated with a local cell identity and wherein said wireless device is associated with a first network cell. The wireless device comprises a receiver arranged to receive a request to report at least one second network cell suitable for handover, a processor arranged to determine the at least one second network cell suitable for handover among a set of available network cells and to form a response comprising the respective local cell identity associated with the at least one suitable second network cell, and a transmitter arranged to transmit the formed response. The processor is arranged to determine a cell identity confusion risk involved for the set of available network cells based on information in the request and based on local cell identities associated with the set of available network cells. The processor is further arranged to measure a global cell identity for each at least one second network cell determined to be involved in a cell identity confusion risk. The processor is further arranged to form the response reporting at least one second network cell suitable for handover so as to comprise information related to the global cell identity for each at least one second network cell determined to be involved in a cell identity confusion.

Thus, the wireless device receives a request to measure a global cell identity for best cell(s) if the second cell identity is subject to a cell identity confusion. Thereby, handover can be made to correct target cell from the first cell (source cell) even though the at least one second cell (target cell) is not uniquely identified by the local cell identity within the coverage of the first cell (source cell).

With the present solution, performance is enhanced as the response from the wireless device uniquely identifies the at least one second network cell when involved in cell identity confusion.

Further, when the at least one second network cell is involved in cell identity confusion the time from reception of a request at the wireless device to the transmittal of a response uniquely identifying the at least one second network cell which is suitable for handover is shortened in relation to prior art solutions.

Further, signaling resource consumption is reduced as the signaling required for providing reporting of at least one second network cell which is suitable for handover is reduced. Both the number of messages and the amount of information transmitted is reduced.

Thus, it is possible to perform handover to the correct target cell even though the cell is involved in cell identity confusion, without the delay and signaling resource consumption necessary with current solutions.

In one option, the request comprises information related to at least one local cell identity subject to a cell identity confusion risk.

In one option, the information related to at least one local cell identity subject to a cell identity confusion risk comprises at least one local cell identity range. Thereby, the transferrred information is reduced.

In one option, the information related to at least one local cell identity subject to a cell identity confusion risk comprises at least one local cell identity not subject to a cell identity confusion risk. In some situations, less data may be needed to be transferred in this way.

In one option, the request to report at least one second network cell suitable for handover comprises information identifying a number of second network cells requested to be reported.

As the number of second network cells requested is defined in the request instead of being preconfigured, a possiblilty to adapt to present conditions is provided.

In one option, the purpose of the request is to obtain information facilitating a handover of the wireless device from the first network cell to one of the second network cell(s).

The present disclosure also relates to a radio access network node for a cellular network, wherein each network cell is associated with a local cell identity. The radio access network node comprises a processor arranged to identify local cell identities having a risk for cell identity confusion, form a request for at least one second network cell suitable for handover from a first network cell, said request comprising information related to the identified local cell identities with risk for cell identity confusion, and a transmitter arranged to transmit the formed request. The request may be transmitted direclty or indirectly to a wireless device.

In one option, the information related to local cell identities subject to a cell identity confusion risk comprises at least one local cell identity range.

In one option, the information related to local cell identities subject to a cell identity confusion risk comprises at least one local cell identity not subject to a cell identity confusion risk.

In one option, the information related to at least one second network cell suitable for handover comprises information identifying a number of second network cells requested to be reported.

In one option, the processor is arranged to identify local cell identities not available for handover and to comprise information related to the identified local cell identities not available for handover in the request.

In one option, the radio access network node further comprises a receiver arranged to receive a response to the transmitted request. In accordance with this option, the processor is arranged to initiate handover to one of the second network cells identified in the response.

In one option, the radio access network node is an evolved Node B, eNB.

In one option, the radio access network node is Radio Network Controller, RNC.

The present disclosure further relates to a method in a wireless device of a cellular network for providing handover support information, wherein each network cell is associated with a local cell identity and wherein said wireless device is attached to a first network cell. The method comprises receiving a request to report at least one second network cell suitable for handover, determining the at least one second network cell suitable for handover among a set of available network cells, forming a response comprising the local cell identity associated with the at least one suitable second network cell, and transmitting the formed response. The method further comprises the steps of determining a cell identity confusion risk involved for the set of available network cells based on information in the request and based on local cell identities associated with the set of available network cells, measuring a global cell identity for each at least one second network cell determined to be involved in a cell identity confusion and wherein the response is formed to comprise information related to the global cell identity, and forming the response to comprise information related to the global cell identity for each at least one second network cell determined to be involved in a cell identity confusion.

In one option, the request comprises information related to at least one local cell identity subject to a cell identity confusion risk.

In one option, the information related to at least one local cell identity subject to a cell identity confusion risk comprises at least one local cell identity range.

In one option, the information related to at least one local cell identity subject to a cell identity confusion risk comprises at least one local cell identity not subject to a cell identity confusion risk.

The present disclosure further relates to a method in a radio access network node of a cellular network for providing handover support information, wherein each network cell is associated with a local cell identity. The method comprises the steps of identifying local cell identities with risk for cell identity confusion, forming a request for at least one second network cell suitable for handover from a first network cell, said request comprising information related to the identified local cell identities with risk for cell identity confusion, and transmitting the formed request. The request may be transmitted direclty or indirectly to a wireless device.

In one option, the information related to local cell identities subject to a cell identity confusion risk comprises at least one local cell identity range.

In one option, the information related to local cell identities subject to a cell identity confusion risk comprises at least one local cell identity not subject to a cell identity confusion risk.

In one option, the information related to at least one second network cell suitable for handover comprises information identifying a number of second network cells requested to be reported.

The present disclosure further relates to a cellular network comprising a wireless device as described above.

In one option, the cellular network comprises a Universal Terrestrial Radio Access Network.

In one option, the cellular network comprises an Evolved Universal Terrestrial Radio Access Network.

In one option, the first network cell and the at least one second network cell uses the same radio access technology.

In one option, the first network cell and the at least one second network cell uses different radio access technologies.

In one option, the cellular network further comprises a radio access network node as described above.

The present disclosure further relates to software for executing the steps of the method in a wireless device as described above.

The present disclosure further relates to software for executing the steps of the method performed in a radio access network node as discussed above.

### BRIEF DESCRIPTION OF THE DRAWINGS

FIG. 1 shows schematically an Evolved Universal Terrestrial Radio Access Network architecture.

FIG. 2 shows a signal scheme illustrating an exchange of signals for handover decision and preparation in an embodiment of a network.

FIG. 3 shows a PRIOR ART signal scheme for handover decision.

FIG. 4 shows a signal scheme illustrating an exchange of signals for handover decision in an embodiment of a network.

FIG. 5 shows an illustration of a PCI confusion situation.

FIG. 6 is a flow chart illustrating an example of method steps in a wireless device of a cellular network for providing handover support.

FIG. 7 is a flow chart illustrating an extended example of method steps in a wireless device of a cellular network for providing handover support.

FIG. 8 is a flow chart illustrating an example of method steps in a radio access network node of a cellular network for providing handover support.

FIG. 9 shows an example of a block scheme over a wireless device for a cellular network.

FIG. 10 shows an example of a block scheme of a radio access network node for a cellular network.

### DETAILED DESCRIPTION

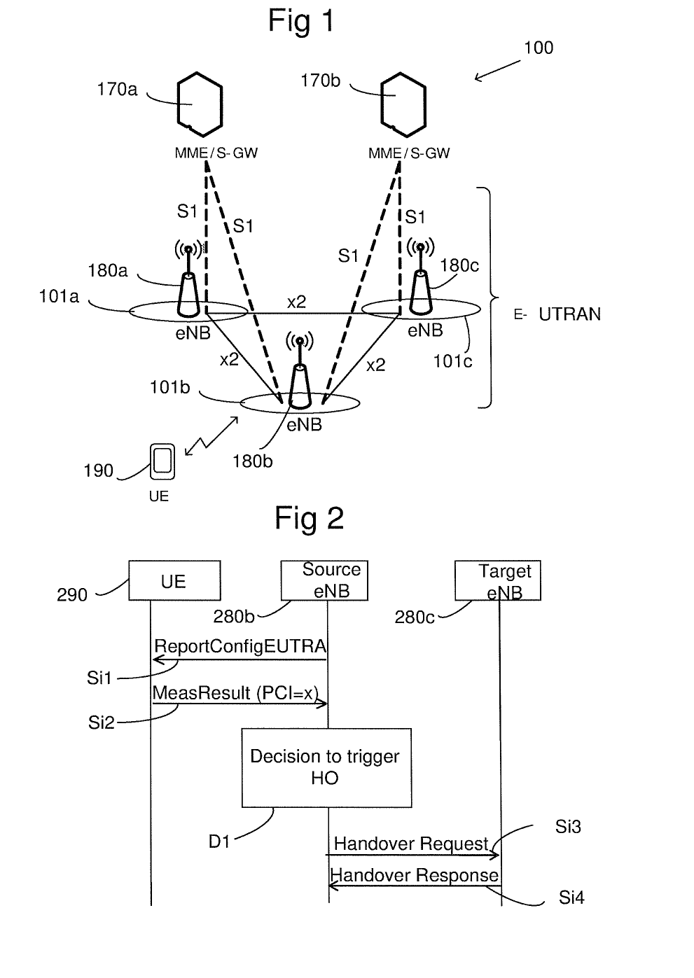

In FIG. 1, an example of a cellular network 100 comprises an Evolved Universal Terrestrial Radio Access Network, E-UTRAN. The E-UTRAN comprises a plurality of evolved Node Bs, eNBs, 180a, 180b, 180c. Each eNB 180a, 180b, 180c is arranged to control one or a plurality of cells 101a, 101b, 101c. Each cell is associated to a local cell identity. The local cell identity is in one example a Physical Cell Identity, PCI. The eNBs 180a, 180b, 180c are interconnected with each other via a first interface X2. The eNBs 180a, 180b, 180c are connected via a second interface S1 to an Evolved Packet Core, EPC. The EPC comprises one or a plurality of Mobility Management Entities, MMEs, and at least one Serving Gateway, S-GW, 170a, 170b. A User Equipment, UE, 190 has access to the cellular network 100 via a source cell 101b. Handover to one of the other cells 101a, 101c can be performed.

In FIG. 2, a source evolved Node B, eNB, 280b is arranged to signal configuration messages Si1 to a User Equipment, UE 290. The configuration messages Si1 comprise in one example a request to report at least one second network cell suitable for handover. The UE 290 is arranged to signal a response Si2 reporting at least one second network cell suitable for handover. The source eNB thereupon decides D1 to trigger handover to a selected target eNB 280c. The source eNB signals a handover request Si3 to the selected target eNB. In response thereto, the selected target eNB 280c signals a handover response Si4.

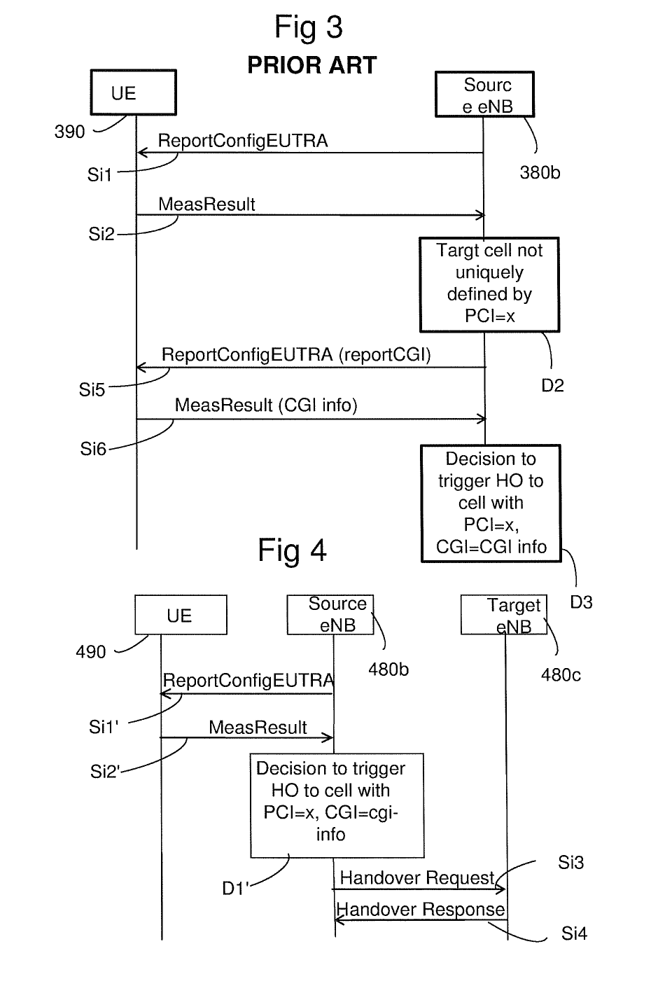

FIG. 3 illustrates a prior art signaling scheme when a selected target evolved Node B, eNB, is involved in PCI confusion. In accordance with this prior art scheme, a source evolved Node B, eNB, 380b is arranged to signal configuration messages Si1 to a User Equipment, UE 390. The configuration message Silcomprises a request to report at least one second network cell suitable for handover. The UE 390 is arranged to signal a response Si2 reporting at least one second network cell suitable for handover. The at least one second network cell suitable for handover is identified by a local cell identity. In one example the local cell identity is a Physical Cell Identity, PCI. The source eNB 380 b may then decide D2 that the selected target cell is not uniquely defined by the local cell identity. The source eNB 380b is then arranged to signal to the UE 390 another configuration message Si5 comprising a request for a global cell identity, GCI. The UE 390 then is arranged to measure the GCI of the selected target cell and signal a response Si6 reporting the GCI of the selected target cell.

The source eNB 380b decides D3 to trigger handover to the selected target cell identified by means of the local cell identity and the global cell identity.

In FIG. 4, a source evolved Node B, eNB, 480b is arranged to signal configuration messages Si1′ to a User Equipment, UE 490. The configuration message Si1′ comprises a request to report at least one second network cell suitable for handover. The configuration message Si1′ further comprises information related to identified local cell identities having a risk for cell identity confusion. The UE 490 is arranged to signal a response Si2′ reporting at least one second network cell suitable for handover. The signaled response Si2′ comprises information identifying the at least one second network cell by means of the local cell identity. However, for each cell determined to be involved in Physical Cell Identity, PCI, confusion, as identified by the information comprised in the configuration message, the signaled response further comprises the global cell identity.

In an example with LTE, the UE 490 identifies a cell by use of a signal sequence from an enumerated set. In LTE there are 504 signal sequences, each associated to a Physical Cell Identity (PCI). A cell can also be identified by the Evolved Cell Global Identifier (ECGI). The ECGI comprises the Public Land Mobile Network (PLMN) and the E-Utran Cell identifiers. Both are broadcasted by the cell. The ECGI uniquely identifies the cell within all LTE networks. The source eNB thereupon decides D1′ to trigger handover to a selected target eNB 480c. The decision D1′ to trigger handover to a target eNB 480c is based on the information in the signaled response Si2′. The source eNB 480b then signals a handover request Si3 to the selected target eNB 480c. In response thereto the selected target eNB 480c signals a handover response Si4.

In using RRC Connected Mode Mobility, the source eNB 480b make the User Equipment, UE, in RRC connected mode to move from one cell to another cell.

The intra-LTE handover process is managed by the eNBs. The source eNB 480b and target eNB 480c communicate through X2 or S1 links, i.e. X2 handover or S1 handover. When the signaled response Si2′ is received from the UE 490, the source eNB selects target cell for handover based on the received measurement report. In the prepared handover, the source eNB prepares the target eNB for the handover and receives information about resources allocated for the UE. The source eNB will then send information received about the target cell to the UE. Finally, it releases resources assigned for the UE after confirmation of the successful handover.

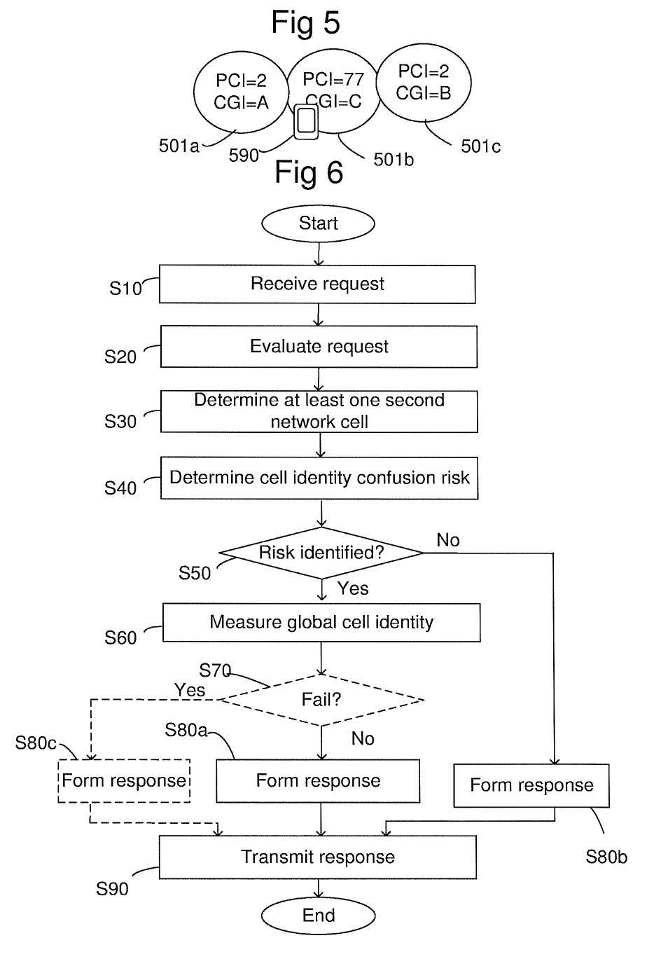

FIG. 5 illustrates a PCI confusion situation in the figure, a User Equipment, UE, 590 can at two different locations in a source cell 501b with PCI=77 hear two different neighboring cells 501a, 501c with PCI=2. When only reporting PCI, in accordance with the prior art scheme of FIG. 3, the UE may report that it wants to perform handover to cell with PCI=2. The UE may hear the cell with PCI=2 corresponding to ECGI=A. However, the eNB may move the UE to the cell with ECGI=B. Thus, handover to a target cell with a PCI that is not unique within the coverage of another cell currently serving the UE, i.e. handover to target cell involved in PCI confusion may result in handover failure. For example small cell deployments may require tight reuse of the PCIs that does not allow for uniqueness on the Pas seen from a large cell. These small cells have Pas within specified known PCI range However, when reporting both local and global cell identity for this specified known PCT range, handover failure is avoided.

In FIG. 9, a wireless device such as a User Equipment, UE, 990 is arranged to provide and report at least one second network cell suitable for handover based on a determined cell identity confusion risk. The UE 990 comprises a receiver 991, a transmitter 992, a processor 993 and a memory 994. The UE 990 is arranged to operate in a cellular network, wherein each network cell is associated with a local cell identity. The UE 990 is associated with a first network cell.

The receiver 991 is arranged to receive a request to report at least one second network cell suitable for handover. The purpose of the request is to obtain information facilitating a handover of the wireless device from the first network cell to one of the second network cell(s). The request comprises information related to at least one identified local cell identity with risk for cell identity confusion. The information related to local cell identities subject to a cell identity confusion risk comprises in one example at least one local cell identity range. In another example, the information related to local cell identities subject to a cell identity confusion risk comprises instead or in addition thereto at least one local cell identity not subject to a cell identity confusion risk. In one example, the request to report at least one second network cell suitable for handover comprises information identifying a number of second network cells requested to be reported. The requested number is for example 1, 2 3, 4 or 5.

Further, in one example the request further comprises local cell identities not available for handover.

The processor 993 is arranged to determine the at least one second network cell suitable for handover among a set of available network cells and to form a response comprising the respective local cell identity associated with the at least one suitable second network cell.

In detail, the processor 993 is further arranged to determine a cell identity confusion risk involved for the set of available network cells based on information in the request and based on local cell identities associated with the set of available network cells. The processor is further arranged to measure a global cell identity for each at least one second network cell determined to be involved in a cell identity confusion risk. The processor 993 is further arranged to comprise in the response reporting at least one second network cell suitable for handover information related to the global cell identity for each at least one second network cell determined to be involved in a cell identity confusion risk.

Thus, the UE is not only configured with normal mobility measurement such as event A5 but also with a request to measure ECGI for the second network cell(s) suitable for handover (best cell(s)) if that or those cells are specified in the received request. The ECGI is for example measured with use of autonomous gap when so requested in a received RRC CONNECTION RECONFIGURATION message. The UE will first perform the normal mobility measurements e.g. A5 event. Then, before the UE reports the second network cell(s) suitable for handover, the UE will decide if the PCI of any of these cells belong to the PCIs specified in the received request. If so, the UE will perform ECGI measurement for example with autonomous gap for those cells belonging to the PCIs specified in the request.

If the request further comprises local cell identities not available for handover, the processor 993 is arranged to not evaluate those cells.

The UE will report the local cell identities or Physical Cell Identities, PCI(s), of the second network cell(s) suitable for handover as well as the ECGI for the second network cell(s) suitable for handover for those cells specified in the received request. Thus, a target cell is identified with unique identity (ECGI) and a source eNB can perform handover to the correct target cell even though it was involved in cell identity confusion.

The processor 993 is arranged to operate in cooperation with the memory 994. The transmitter 992 is arranged to transmit the formed response.

In FIG. 6, a method in a wireless device of a cellular network for providing handover support information is described, wherein each network cell is associated with a local cell identity and wherein said wireless device is attached to a first network cell. The method comprising receiving S10 a request to report at least one second network cell suitable for handover, evaluating S20 the request and determining S30 the at least one second network cell suitable for handover among a set of available network cells. A cell identity confusion risk involved for the set of available network cells is determined S40 based on information in the request and based on local cell identities associated with the set of available network cells. If a risk is identified S50 for any of the second network cells suitable for handover, a global cell identity is measured S60 for that or those second cells. A response is then formed S80a, S80b, S80c. If a risk for cell identity confusion has not been determined and consequently global cell identity measurement has not been performed, the response is formed S80b so as to comprise the local cell identity associated with the at least one suitable second network cell. If on the other hand, a risk for cell identity confusion has been determined and consequently global cell identity measurement has been performed, the response is formed S80a so as to comprise the local cell identity associated with the at least one suitable second network cell and the global cell identity associated to those second cells for which the global cell identity has been measured. If the measurement of the global cell identity fails S70 for any of the measured second cells, the response is in one example formed S80c accordingly. In one example the response is then formed S80c so as to comprise information related to the local cell identity for which the measurement has failed. After the response has been formed, is transmitted S90.

At least some of the steps above are in one example performed in parallel or in another order. In one example, the steps for evaluating S20 the request and determining S30 the at least one second network cell suitable for handover are performed in another order.

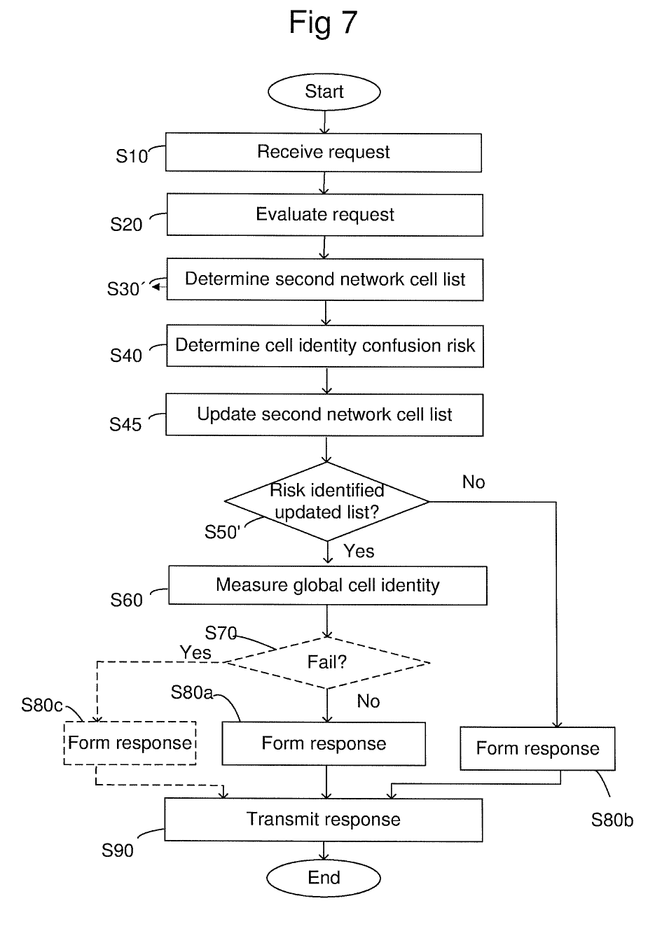

In FIG. 7, an extended method in a wireless device of a cellular network for providing handover support information is described, wherein each network cell is associated with a local cell identity and wherein said wireless device is attached to a first network cell. The method comprising receiving S10 a request to report at least one second network cell suitable for handover, evaluating S20 the request and determining S30′ a second network cell list among a set of available network cells. Then, a cell identity confusion risk involved is determined S40 for the determined S30′ second network cell list based on information in the request and based on local cell identities associated with the cells of the second network cell list. The second network cell list is thereafter updated S45. If there is a risk identified S50″ with any of the cells in the updated second network cell list, then a global cell identity for that or those cells is measured S60.

As described in relation to FIG. 6, a response is then formed S80a, S80b, S80c. Accordingly, if a risk for cell identity confusion has not been determined and consequently global cell identity measurement has not been performed, the response is formed S80b so as to comprise the local cell identity associated with each suitable second network cell of the second network cell list. If on the other hand, a risk for cell identity confusion has been determined and consequently global cell identity measurement has been performed, the response is formed S80a so as to comprise the local cell identities of the updated second network cell list. The response is further formed S80b so as to comprise the global cell identities associated with those cells of the updated second network cell list for which a cell identity confusion risk has been determined. If the measurement of the global cell identity fails S70 for any of the measured cells, the response is in one example formed S80c accordingly. In one example the response is then formed S80c so as to comprise information related to the local cell identity for which the measurement has failed. After the response has been formed, is transmitted S90. If several measured second cells are included in the transmitted response S90, the transmitted response could be any combination of one or more of the formed responses S80a, S80b, S80c

In FIG. 10, a radio access network node 1080 for a cellular network such as an evolved Node B, eNB, is arranged to form and transmit a request to a wireless device such as a User Equipment, UE. The eNB 1080 comprises a receiver 1081, a transmitter 1082, a processor 1083 and a memory 1084. The eNB 1080 is arranged to operate in a cellular network, wherein each network cell is associated with a local cell identity.

The processor 1083 is arranged to identify local cell identities having a risk for cell identity confusion. The identification of the local cell identities having a risk for cell identity confusion involves in one example using information related to PCI ranges for small cells or pico cells as local cell identities having a risk for cell identity confusion. The information related to local cell identities subject to a cell identity confusion risk comprises in one example at least one local cell identity range. The information related to local cell identities subject to a cell identity confusion risk comprises in one example at least one local cell identity not subject to a cell identity confusion risk. The information related to at least one second network cell suitable for handover comprises in one example information identifying a number of suitable second network cells requested to be reported. The number of suitable second network cells is in one example a number within a range from 1 to S. Further, in one example the processor is arranged to identify local cell identities of second network cells not available for handover and to comprise information related to the identified local cell identities not available for handover in the request. Those local cell identities are for example provided in the network node from an operation and maintenance system (not shown). The processing unit is arranged to cooperate with memory 1084 storing information. The information stored comprises in one example information related to local cell identities having a risk for cell identity confusion. The memory is in one example arranged to store information related to local cell identities not available for handover. In one example, the memory 1084 is not physically available

The processor 1083 is further arranged to form a request for at least one second network cell suitable for handover from a first network cell. The request comprises information related to the identified local cell identities with risk for cell identity confusion. If cell(s) not available for handover has/have been identified, local cell identities associated to those cells are also comprised in the request.

The transmitter 1082 is arranged to transmit the formed request to the UE.

The receiver 1081 is arranged to receive a response to the transmitted request. The processor 1083 is then arranged to initiate handover to one of the second network cells identified in the response. The response comprises information identifying at least one second network cell suitable for handover. The information comprises a local cell identity. Further, for cells involved in cell identity confusion, information comprises also a global cell identity.

The radio access network node is described in relation to an example with an evolved Node B, eNB. The radio access network node is in an alternative example another type of radio access network node, such as a Radio Network Controller, RNC.

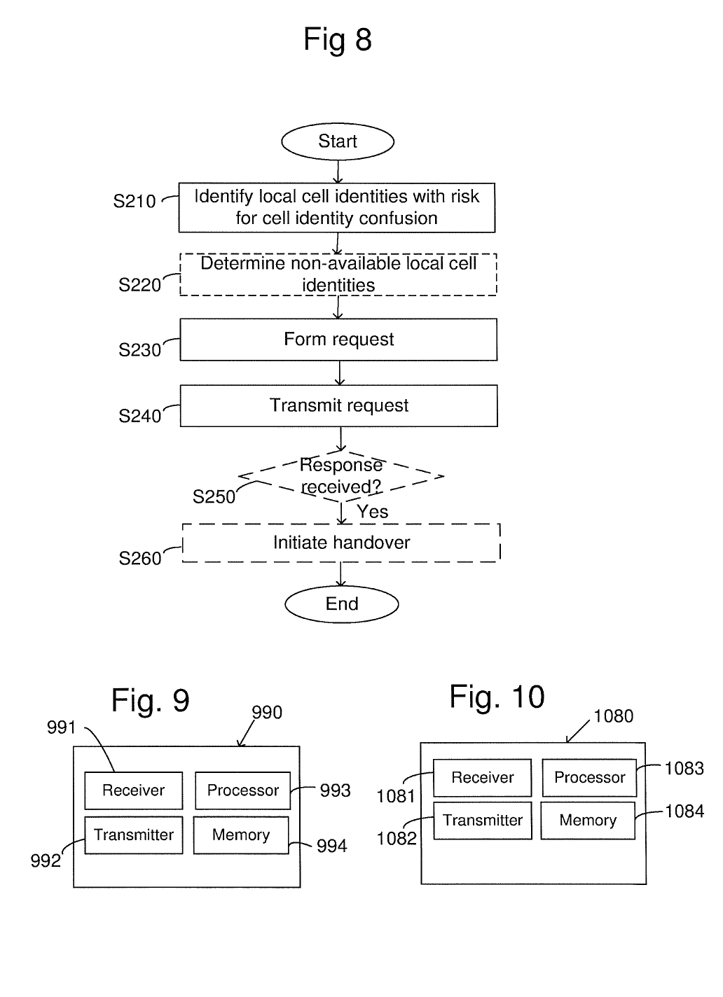

In FIG. 8, a method performed in a radio access network node of a cellular network for providing handover support information is described, wherein each network cell is associated with a local cell identity. The method comprises steps of identifying S210 local cell identities with risk for cell identity confusion, forming S230 a request for at least one second network cell suitable for handover from a first network cell, said request comprising information related to the identified local cell identities with risk for cell identity confusion, and transmitting S240 the formed request to a wireless device. In one example, the method also comprises a step of determining S220 local cell identities of cells not available for handover. In this case also this information is comprised in the request and transmitted S240. In one example, reception of a response S250 is monitored. In one example, handover is initiated S260 after reception of the response.

1. A wireless device for a cellular network, wherein each network cell is associated with a local cell identity and wherein said wireless device is associated with a first network cell, said wireless device comprising:
a receiver arranged to receive a request to report at least one second network cell suitable for handover;
a processor arranged to determine the at least one second network cell suitable for handover among a set of available network cells and to form a response comprising the respective local cell identity associated with the at least one suitable second network cell; and
a transmitter arranged to transmit the formed response, wherein the processor is further arranged to:
determine a cell identity confusion risk involved for the set of available network cells based on information in the request and based on local cell identities associated with the set of available network cells;
measure a global cell identity for each at least one second network cell determined to be involved in a cell identity confusion risk; and
form the response reporting at least one second network cell suitable for handover so as to comprise information related to the global cell identity for each at least one second network cell determined to be involved in a cell identity confusion risk.

2. The wireless device according to claim 1, wherein the request comprises information related to at least one local cell identity subject to a cell identity confusion risk.

3. The wireless device according to claim 2, wherein the information related to at least one local cell identity subject to a cell identity confusion risk comprises at least one local cell identity range.

4. The wireless device according to claim 2, wherein the information related to at least one local cell identity subject to a cell identity confusion risk comprises at least one local cell identity not subject to a cell identity confusion risk.

5. The wireless device according to claim 1, wherein the request to report at least one second network cell suitable for handover comprises information identifying a number of second network cells requested to be reported.

6. The wireless device according to claim 1, where the purpose of the request is to obtain information facilitating a handover of the wireless device from the first network cell to one of the second network cell(s).

7. A radio access network node for a cellular network, wherein each network cell is associated with a local cell identity, said radio access network node comprising:
a processor arranged to:
identify local cell identities having a risk for cell identity confusion;
form a request for at least one second network cell suitable for handover from a first network cell, said request comprising information related to the identified local cell identities with risk for cell identity confusion; and
a transmitter arranged to transmit the formed request.

8. The radio access network node according to claim 7, wherein the information related to local cell identities subject to a cell identity confusion risk comprises at least one local cell identity range.

9. The radio access network node according to claim 8, wherein the information related to local cell identities subject to a cell identity confusion risk comprises at least one local cell identity not subject to a cell identity confusion risk.

10. The radio access network node according to claim 7, wherein the information related to at least one second network cell suitable for handover comprises information identifying a number of second network cells requested to be reported.

11. The radio access network node according to claim 7, wherein the processor is arranged to identify local cell identities not available for handover and to comprise information related to the identified local cell identities not available for handover in the request.

12. The radio access network node according to claim 7, further comprising a receiver arranged to receive a response to the transmitted request, wherein the processor is arranged to initiate handover to one of the second network cells identified in the response.

13. The radio access network node according to claim 7, wherein the radio access network node is an evolved Node B, eNB.

14. The radio access network node according to claim 7, wherein the radio access network node is Radio Network Controller, RNC.

15. A method in a wireless device of a cellular network for providing handover support information, wherein each network cell is associated with a local cell identity and wherein said wireless device is attached to a first network cell, said method comprising:
receiving a request to report at least one second network cell suitable for handover;
determining the at least one second network cell suitable for handover among a set of available network cells;
forming a response comprising the local cell identity associated with the at least one suitable second network cell; and
transmitting the formed response, wherein the method further comprises the steps of:
determining a cell identity confusion risk involved for the set of available network cells based on information in the request and based on local cell identities associated with the set of available network cells;
measuring a global cell identity for each at least one second network cell determined to be involved in a cell identity confusion and wherein the response is formed to comprise information related to the global cell identity; and
forming the response to comprise information related to the global cell identity for each at least one second network cell determined to be involved in a cell identity confusion.

16. The method in a wireless device according to claim 15, wherein the request comprises information related to at least one local cell identity subject to a cell identity confusion risk.

17. The method in a wireless device according to claim 16, wherein the information related to at least one local cell identity subject to a cell identity confusion risk comprises at least one local cell identity range.

18. The method in a wireless device according to claim 16, wherein the information related to at least one local cell identity subject to a cell identity confusion risk comprises at least one local cell identity not subject to a cell identity confusion risk.

19. A method in a radio access network node of a cellular network for providing handover support information, wherein each network cell is associated with a local cell identity, said method comprising:
identifying local cell identities with risk for cell identity confusion;
forming a request for at least one second network cell suitable for handover from a first network cell, said request comprising information related to the identified local cell identities with risk for cell identity confusion; and
transmitting the formed request.

20. The method in a radio access network node according to claim 19, wherein the information related to local cell identities subject to a cell identity confusion risk comprises at least one local cell identity range.

21. The method in a radio access network node according to claim 19, wherein the information related to local cell identities subject to a cell identity confusion risk comprises at least one local cell identity not subject to a cell identity confusion risk.

22. The method in a radio access network node according to claim 19, wherein the information related to at least one second network cell suitable for handover comprises information identifying a number of second network cells requested to be reported.

23. A computer program comprising computer-executable instructions for causing a wireless device to perform the steps of the method according to claim 15.

24. A computer program comprising computer-executable instructions for causing a radio access network node to perform the steps of the method according claim 19.
